(19) United States
(12) Patent Application Publication
(10) Pub. No.: US 2009/0009597 A1
(43) Pub. Date: Jan. 8, 2009

(54) Method Apparatus and System of Remote Monitoring

(76) Inventor: Shahar Belkin, Kibbutz Nahal-Oz (IL)

Correspondence Address: Pearl Cohen Zedek Latzer, LLP, 1500 Broadway, 12th Floor, New York, NY, 10036, US

(21) Appl. No.: 11/662,643

(22) PCT Filed: Sep. 13, 2005
(86) PCT No.: PCT/IL05/00975

§ 371 Date: Sep. 15, 2008

Related U.S. Application Data
(60) Provisional application No. 60/608,881, filed on Sep. 13, 2004.

(51) Int. Cl. H04N 7/18

(52) U.S. Cl. 348/143; 348/E05.001

(57) ABSTRACT

Embodiments of the present invention provide a method, apparatus and system of remote monitoring. The apparatus according to some demonstrative embodiments of the invention may include a camera positioned to capture an image within a field of view including a monitored area; a transmitter to transmit data corresponding to the image over a communication channel during a transmission time period; and a blocking arrangement to selectively block at least part of the field of view during at least part of said transmission time period, in a conspicuous manner. Other embodiments are described and claimed.

### CROSS-REFERENCE TO RELATED APPLICATIONS

This application claims priority of U.S. Provisional Patent Application, 60/608,881, filed Sep. 13, 2004, the entire disclosure of which is incorporated herein by reference.

### BACKGROUND OF THE INVENTION

Remote monitoring systems may include one or more cameras in communication with a monitoring station and positioned at one or more predetermined locations to be monitored. The cameras may be able to capture a predetermined scene and transmit, e.g., to the monitoring station and/or to any other suitable remote device, image data corresponding to the captured scene. Such systems may be implemented for many desired purposes, for example, security purposes.

Some monitoring cameras may be able to selectively transmit the image data, e.g., to the monitoring station, according to a predetermined transmission scheme. For example, some cameras, e.g., implemented for security purposes, may be able to transmit image data to the monitoring station upon detecting a movement in the captured scene.

A person may feel uncomfortable in the presence of a monitoring camera even during time periods in which the camera is not actively transmitting image data, for example, because the person cannot determine with certainty whether or not image data is actually being transmitted by the camera. Furthermore, a monitored person may feel unsafe because the monitoring camera may be abused, e.g., electronically manipulated, to transmit the image data without authorization.

As a result, the potential market for implementing conventional monitoring systems to monitor premises, for example, private residences and/or offices, has not been fully realized.

### SUMMARY OF DEMONSTRATIVE EMBODIMENTS OF THE INVENTION

Some demonstrative embodiments of the invention provide a method, apparatus and system of remote monitoring.

Some demonstrative embodiments of the invention include a monitoring unit including a camera positioned to capture an image within a field of view including a monitored area; a transmitter to transmit data corresponding to the image over a communication channel during a transmission time period; and a blocking arrangement to selectively block at least part of the field of view during at least part of said transmission time period, in a conspicuous manner.

According to some demonstrative embodiments of the invention, the blocking arrangement is able to selectively block at least part of the field of view based on a control signal indicating the data is being transmitted over the channel.

According to one demonstrative embodiment of the invention, the blocking arrangement may include a shutter to be positioned in at least first and second positions. The shutter, when in the first position, may at least partially block the field of view of the camera. The blocking arrangement may also include a controller to controllably move the shutter between the first and second positions based on the control signal. A difference between the first and second positions may be conspicuous, for example, to an observer in the monitored area. The monitoring unit may also include, for example, a position maintainer to maintain the shutter in a selected one of the first and second positions, e.g., independently of the control signal.

According to another demonstrative embodiment of the invention, the blocking arrangement may include a controller to controllably move the camera between at least first and second positions based on the control signal. When in the first position, the camera may have, for example, a field of view not including at least part of the monitored area. A difference between the first and second positions may be conspicuous to an observer in the monitored area.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a remote monitoring system according to some demonstrative embodiments of the invention;

FIG. 2 is a schematic illustration of a camera configuration according to one demonstrative embodiment of the invention;

FIG. 3 is a schematic illustration of a camera configuration according to another demonstrative embodiment of the invention; and

FIG. 4 is a schematic illustration of a camera configuration according to yet another demonstrative embodiment of the invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF DEMONSTRATIVE EMBODIMENTS OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits may not have been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

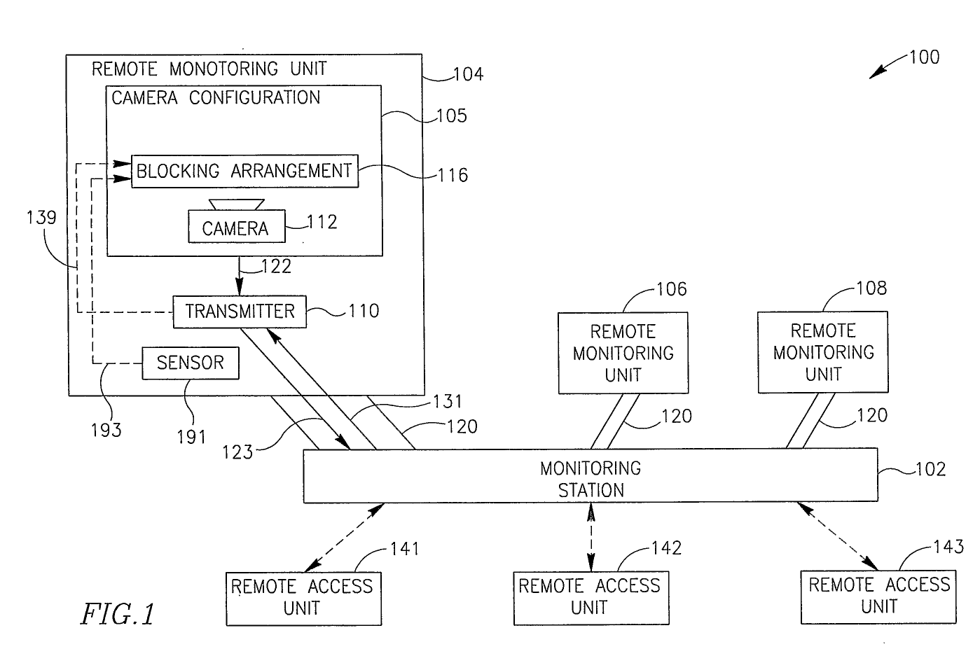

Reference is made to FIG. 1, which schematically illustrates a remote monitoring system 100 according to some demonstrative embodiments of the present invention.

According to some demonstrative embodiments of the invention, system 100 may include a monitoring station 102 able to communicate with one or more remote monitoring units, e.g., remote monitoring units 104, 106 and 108, via one or more communication channels 120. Communication channels 120 may include any suitable communication channels, e.g., one or more wired or wireless communication channels as are known in the art. For example, system 100 may be part of a wireless communication system, a digital communication system, or a satellite communication system.

According to some demonstrative embodiments of the invention, one or more of remote units 104, 106 and 108 may include a camera configuration 105, e.g., including a camera 112, and a blocking arrangement 116, as are described in detail below.

According to some demonstrative embodiments of the invention, one or more of remote units 104, 106, and 108 may also include an transmitter 110 able to receive from camera 112 an image data signal 122, e.g., corresponding to an image or a scene captured by camera 112. Transmitter 110 may be able to encode the image data of signal 122 and produce an encoded signal 123 having a form suitable for transmission via channel 120, e.g., using any suitable encoding method as known in the art. For example, transmitter 110 may be or may include the Ozline-4VC encoder available from by Ozvision Ltd., Israel.

According to some demonstrative embodiments of the invention, transmitter 110 may be able to selectively transmit the encoded data to station 102, e.g., in accordance with one or more predetermined transmission schemes. For example, transmitter 110 may be able to produce signal 123 upon receiving a control signal 131, e.g., from station 102. Additionally or alternatively, transmitter 110 may be able to process the image data of signal 122 and to selectively transmit signal 123 according to one or more predetermined criteria. For example, transmitter 110 may be adapted to detect a change e.g., indicative of a movement, in the image data of signal 122, e.g., using any suitable motion detection algorithm as known in the art, and to produce signal 123 upon detection of one or more change fulfilling one or more predetermined motion detection rules.

Aspects of the invention are described herein in the context of a demonstrative embodiment of a camera, e.g., camera 112, an encoder, a transmitter, e.g., transmitter 110, and a blocking arrangement, e.g., arrangement 116, being separate units of a remote unit, e.g., remote unit 104. However, it will be appreciated by those skilled in the art that, according to other embodiments of the invention, any other combination of integral or separate units may also be used to provide the desired functionality. For example, in some embodiments of the invention the camera may include the transmitter.

According to demonstrative embodiments of the invention, blocking arrangement 116 may be able to selectively block the field of view of camera 112, for example, when image data is transmitted out from remote unit 104, e.g., to station 102, as described below. For example, blocking arrangement 116 may be controlled by a control signal 139, which may be produced by transmitter 110, e.g., when transmitting image data to station 102, e.g., via signal 123. Additionally or alternatively, blocking arrangement 116 may be controlled by a control signal 193, which may be produced by a data transmission sensing unit 191 able to detect a transmission to station 102, e.g., via signal 123. The physical blocking of the field of view of camera 112 may be performed in a manner noticeable to a person or persons in the monitored area, e.g., clearly and conspicuously, whereby the person or persons in the monitored area may be reassured that they are not being monitored, as further explained below.

According to some demonstrative embodiments of the invention, monitoring station may include any suitable hardware and/or circuitry, e.g., as are known in the art, for controllably receiving the image data of one or more of the remote monitoring units, and, optionally, for processing the image data, e.g., using any suitable algorithm as known in the art.

According to some demonstrative embodiments of the invention, system 100 may also include one or more remote access units, e.g., devices 141, 142 and 143, able to communicate with monitoring station 102, e.g., to receive information relating to one or more of remote monitoring units 104, 106 and 108. For example, one or more of access units 141, 142 and 143 may include a computing platform, e.g., a personal computer, a desktop computer, a mobile computer, a laptop computer, a notebook computer, a terminal, a workstation, a server computer, a Personal Digital Assistant (PDA) device, a tablet computer, a network device, or other suitable computing device. For example, one or more of access units 141, 142 and 143 may be able to communicate with station 102 via a secure or non-secure communication channel, e.g., a wired or wireless communication channel as is known in the art. One or more of units 141, 142 and 143 may be able to receive from station 102 an indication, e.g., a visual and/or an audible indication, corresponding to a status of a remote location at which a corresponding one of units 140, 106 and 108 is positioned. For example, access unit 141 may be able to receive an image corresponding to the image captured by camera 112. Additionally or alternatively, access unit 141 may be able to receive an indication, e.g., a visual and/or audible alert, corresponding to a change or a movement detected in one or more of the image captured by camera 112.

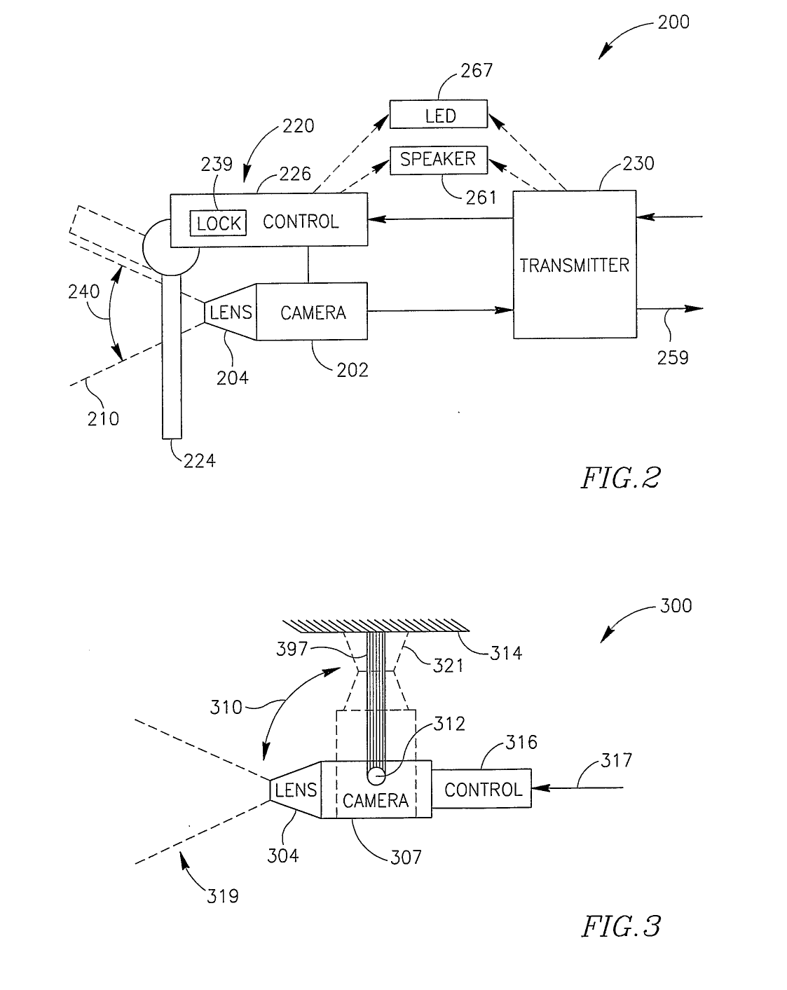

Reference is made to FIG. 2, which schematically illustrates a camera configuration 200 according to one demonstrative embodiment of the invention.

According to the demonstrative embodiment illustrated in FIG. 2, camera configuration 200 may include a camera 202 having a lens or a lens system 204 able to capture an image or a scene of a field of view 210. Camera 202 may include any suitable camera as is known in the art. For example, camera 202 may include the Dinion^{xf} security camera available from Bosch security systems, New York, USA. In some demonstrative embodiments of the invention, camera 202 and/or lens system 204 may be adapted to adjust the size and/or direction of field of view 210, for example, using a zooming mechanism, and/or a positioning mechanism for controllably rotating and/or displacing camera 202 and/or parts of lens system 204. Such mechanisms are well known in the art.

According to demonstrative embodiments of the invention, camera configuration 200 may include a blocking arrangement 220 to selectively block field of view 210 based on a control signal 222, e.g., received from a transmitter 230, such that blocking arrangement 220 may selectively obstruct camera 202, e.g., in a manner conspicuous to a person in or around field of view 210, from capturing the image of field of view 210.

According to demonstrative embodiments of the invention, blocking arrangement 220 may include a shutter 224 and a control mechanism 226 for controllably moving shutter 226, e.g., in accordance with a value of signal 222. For example, control mechanism 226 may be able to controllably rotate shutter 224, e.g., as indicated by arrow 240, between an “open” position wherein the field of view of camera 204 is not blocked by shutter 224, and a “closed” position wherein the field of view of camera 202 is blocked by shutter 224. Blocking arrangement 220 may include any suitable mechanism and/or circuitry, e.g., as are known in the art, for controllably rotating shutter 224 between the “open” and “closed” positions. For example, control mechanism 226 may be able to maintain shutter 224 at the “open” position as long as mechanism 226 receives signal 222 having a value indicative of transmitter 230 transmitting image data captured by camera 202, for example, to a monitoring station, e.g., station 102 (FIG. 1). Control mechanism 226 my be able to rotate shutter 224 to the “closed” position upon receiving signal 222 having a value indicative of transmitter 230 not transmitting image data captured by camera 202, e.g., to the monitoring station, and/or if signal 222 is not received by control mechanism 226.

According to some demonstrative embodiments of the invention, camera configuration 200 may also include a locking module 239 able to selectively lock shutter 224 in a desired one of the “open” and “closed” positions, e.g., such that shutter 224 is maintained at the desired position independently of the value of signal 222. According to some demonstrative embodiments of the invention, locking module 239 may include a manual mechanism, e.g., including a pin (not shown), for manually securing shutter 224 in either one of the “closed” or “open” positions. Additionally or alternatively, locking module 239 may include any suitable, e.g., electrical, “open/close” button or switch, e.g., as is known in the art, to control mechanism 226 to maintain shutter 224 in a desired one of the “open” and “closed” positions.

According to some demonstrative embodiments of the invention, camera configuration may also include one or more indicators for indicating whether or not transmitter 230 is transmitting signals 259. The one or more indicators may include, for example, a visual indicator, e.g., a Light Emitting Diode (LED) 267, and/or an audible indicator, e.g., a speaker 261, associated with transmitter 230 and/or blocking arrangement 220 and able to produce a visual and/or audible indication whenever signals 259 are transmitted. LED 267 and/or speaker 261 may be implemented as separate units or as part of camera 202 or blocking arrangement 220.

Some demonstrative embodiments of the invention are described above in relation to a camera configuration, e.g., configuration 200, including a camera, e.g., camera 202, and a blocking arrangement, e.g., arrangement 220, able to selectively block a field of view of the camera by selectively moving a blocking element, e.g., shutter 224, between “open” and “closed” positions. However it will be appreciated by those skilled in the art that according to other embodiments of the invention the camera configuration may include a camera and a blocking arrangement able to selectively block the field of view of the camera using any other mechanism and/or method. For example, the blocking arrangement may include a mechanism for moving and/or rotating the camera such that the lens of the camera captures an image in a predetermined direction, e.g., as described below.

Reference is made to FIG. 3, which schematically illustrates a camera configuration 300 according to another demonstrative embodiment of the invention.

According to the demonstrative embodiment illustrated in FIG. 3, camera configuration 300 may include a camera 302 having a lens or lens system 304 and supported by a support element, e.g., a supporting pole 397. Configuration 300 may also include a controllable rotation mechanism 316, e.g., including a controller to control a motor (not shown) to selectively rotate camera 302, e.g., around a rotation axis 312. For example, rotation mechanism 316 may be able to selectively rotate camera 302, e.g., as indicated by arrow 310, between a first, e.g., horizontal, position and a second, e.g., vertical, position in accordance with a control signal 317, e.g., received from transmitter 110 (FIG. 1). According to some demonstrative embodiments of the invention, lens system 304 may capture an image of a first field of view 319 when camera 302 is at the first position, and a second field of view 321 when camera 302 is at the second position. The first and second positions of camera 302 may be chosen such that field of view 319 may include a desired field of view for monitoring, e.g., for remote monitoring, and field of view 321 may include a field of view not useful for monitoring. For example, the second position of the camera may be chosen such that lens system 304 may be directed to a surface 314, e.g., of a wall or a ceiling, with no significant field of view in the monitoring area. It will be appreciated that when camera 302 is in the second position, a person or persons in the area to be monitored may be reassured that they are not being monitored.

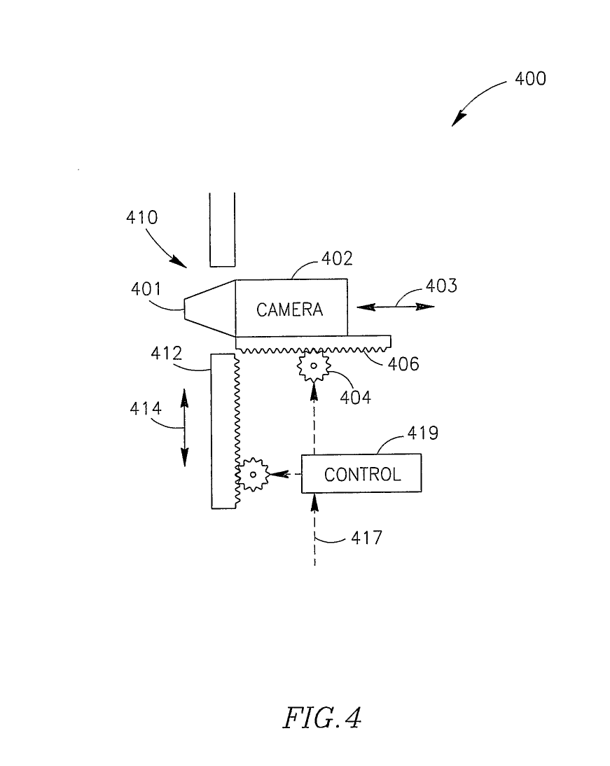

Reference is made to FIG. 4, which schematically illustrates a camera configuration 400 according to yet another demonstrative embodiment of the invention.

According to the demonstrative embodiment illustrated in FIG. 4, camera configuration 400 may include a camera 402 having a lens or lens system 401. Configuration 400 may have a first mode of operation, e.g., wherein a field of view of lens 401 is blocked; and a second mode of operation, e.g., wherein lens system 401 may capture a field of view useful for monitoring, as described below.

According to some demonstrative embodiments of the invention, camera 402 may be selectively movable e.g., as indicated by arrow 403, between first and second positions corresponding to the first and second operation modes of configuration 400, respectively. For example, configuration 404 may include a motor arrangement 404 for sliding camera 402 along a track 406. Configuration 400 may also include a blocking arrangement 410 for selectively blocking a field of view of lens system 401. For example, blocking arrangement 410 may include a shutter 412, which may be selectively moveable, e.g., as indicated by arrow 414, between open and closed positions corresponding to the first and second modes of operation of configuration 400. Configuration 400 may also include a controller 419 to control the movement of shutter 412 between the closed and open positions, and/or the movement of camera 402 between the first and second positions, for example, in accordance with a control signal 417, e.g., received from transmitter 110 (FIG. 1). When configuration 400 is in the first mode of operation, the field of view of lens 401 may be conspicuously blocked by shutter 412.

It will be appreciated by those skilled in the art that a person may generally feel comfortable in the presence of a camera configuration including a blocking arrangement according to demonstrative embodiments of the invention, since the person may be certain that images are not being captured by the camera when the camera is in the “closed” position. Thus, the remote monitoring systems with camera configurations according to embodiments of the invention, e.g., as are described above, may be implemented for monitoring any desired one or more remote locations, e.g., including private and/or sensitive locations, for example, private residences, apartments and/or offices, without instilling unnecessary concerns in the residents or employees at such locations during non-monitored time periods, for example, during office hours in case of an office environment.

Embodiments of the present invention may be implemented by software, by hardware, or by any combination of software and/or hardware as may be suitable for specific applications or in accordance with specific design requirements. Embodiments of the present invention may include units and sub-units, which may be separate of each other or combined together, in whole or in part, and may be implemented using specific, multi-purpose or general processors, or devices as are known in the art. Some embodiments of the present invention may include buffers, registers, storage units and/or memory units, for temporary or long-term storage of data and/or in order to facilitate the operation of a specific embodiment.

While certain features of the invention have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

What is claimed is:

1. A monitoring unit comprising:
a camera positioned to capture an image within a field of view including a monitored area;
a transmitter to transmit data corresponding to said image over a communication channel during a transmission time period; and
a blocking arrangement to selectively block at least part of said field of view during at least part of said transmission time period, in a conspicuous manner.

2. The monitoring unit of claim 1, wherein said blocking arrangement is to selectively block at least part of said field of view based on a control signal indicating said data is being transmitted over said channel.

3. The monitoring unit of claim 2, wherein said blocking arrangement comprises:
a shutter to be positioned in at least first and second positions, said shutter, when in said first position, at least partially blocks said field of view; and
a controller to controllably move said shutter between said first and second positions based on said control signal,
wherein a difference between said first and second positions is conspicuous to an observer in said monitored area.

4. The monitoring unit of claim 3 comprising a position maintainer to maintain said shutter in a selected one of said first and second positions independently of said control signal.

5. The monitoring unit of claim 2, wherein said blocking arrangement comprises a controller to controllably move said camera between at least first and second positions based on said control signal, wherein when in said first position, said camera has a field of view not including at least part of said monitored area, and wherein a difference between said first and second positions is conspicuous to an observer in said monitored area.

6. The monitoring unit of claim 5, wherein said first and second positions comprise first and second orientations about a rotation axis of said camera, said controller is able to controllably rotate said camera between first and second orientations.

7. The monitoring unit of claim 6, wherein when in said first orientation, said camera is directed towards a predetermined surface.

8. A method of monitoring an area comprising:
positioning a camera to capture an image within a field of view including a monitored area;
transmitting data corresponding to said image over a communication channel during a transmission time period; and
selectively blocking at least part of said field of view during at least part of said transmission time period, in a conspicuous manner.

9. The method of claim 8 comprising generating a control signal indicating said data is being transmitted over said channel, wherein said selectively blocking comprises selectively blocking at least part of said field of view based on said control signal.

10. The method of claim 9 comprising:
controllably moving a shutter between first and second positions based on said control signal,
wherein said shutter, when in said first position, at least partially blocks said field of view, and wherein a difference between said first and second positions is conspicuous to an observer in said monitored area.

11. The method of claim 10 comprising maintaining said shutter in a selected one of said first and second positions independently of said control signal.

12. The method of claim 9 comprising controllably move said camera between at least first and second positions based on said control signal, wherein when in said first position, said camera has a field of view not including at least part of said monitored area, and wherein a difference between said first and second positions is conspicuous to an observer in said monitored area.

13. The method of claim 12, wherein said first and second positions comprise first and second orientations about a rotation axis of said camera, and wherein controllably moving said camera comprises controllably rotating said camera between first and second orientations.

14. The method of claim 12, wherein when in said first orientation, said camera is directed towards a predetermined surface.

15. A monitoring system comprising:
a monitoring station; and
at least one monitoring unit comprising:
a camera positioned to capture an image within a field of view including a monitored area;
a transmitter to transmit to said monitoring station over a communication channel, data corresponding to said image during a transmission time period; and
a blocking arrangement to selectively block at least part of said field of view during at least part of said transmission time period, in a conspicuous manner.

16. The monitoring system of claim 15, wherein said blocking arrangement is to selectively block at least part of said field of view based on a control signal indicating said data is being transmitted over said channel.

17. The monitoring system of claim 16, wherein said blocking arrangement comprises:
a shutter to be positioned in at least first and second positions, said shutter, when in said first position, at least partially blocks said field of view; and
a controller to controllably move said shutter between said first and second positions based on said control signal,
wherein a difference between said first and second positions is conspicuous to an observer in said monitored area.

18. The monitoring system of claim 17 comprising a position maintainer to maintain said shutter in a selected one of said first and second positions independently of said control signal.

19. The monitoring system of claim 16, wherein said blocking arrangement comprises a controller to controllably move said camera between at least first and second positions based on said control signal, wherein when in said first position, said camera has a field of view not including at least part of said monitored area, and wherein a difference between said first and second positions is conspicuous to an observer in said monitored area.

20. The monitoring system of claim 19, wherein said first and second positions comprise first and second orientations about a rotation axis of said camera, said controller is able to controllably rotate said camera between first and second orientations.

21. The monitoring system of claim 20, wherein when in said first orientation, said camera is directed towards a predetermined surface.
